(19) United States
(12) Patent Application Publication
(10) Pub. No.: US 2004/0056979 A1
(43) Pub. Date: Mar. 25, 2004

(54) Multi-windows on screen display control system and method thereof

(76) Inventor: Yong-Nam Kim, Kyungki-do (KR)

Correspondence Address: Douglas W Sprinkle, Gifford Krass Groh Sprinkle Anderson & Citkowski, Suite 400, 280 North Old Woodward, Birmingham, MI, 48009, US

(21) Appl. No.: 10/432,935

(22) PCT Filed: Nov. 28, 2001
(86) PCT No.: PCT/KR01/02058

(30) Foreign Application Priority Data
Nov. 28, 2000 (KR) 2000/71332

(51) Int. Cl. H04N 7/00

(52) U.S. Cl. 348/552

(57) ABSTRACT

Disclosed is a system that allows the user of a computer having a plurality of integrated monitors controlled by A one central processing unit (CPU) to adjust the display controls of the individual monitors with a single display adjustment key switch set. The display adjustment system includes a body, a plurality of monitors integrated with the body, an analog digital (AD) board, and an input. The AD board includes a display adjustment key switch set and an on-screen display (OSD) controller for the user to selectively adjust the display controls of the individuals monitors, and the OSD controller is built in the body. The display adjustment key switch set, formed as a set of buttons is mounted outside the body for the user to adjust the display controls by pressing the buttons.

### BACKGROUND OF THE INVENTION

(a) Field of the Invention

The present invention relates to a display adjustment system for a computer having a plurality of integrated monitors. More specifically, the present invention relates to a system that allows the user of a computer having a plurality of integrated monitors controlled by one central processing unit (CPU) to adjust the display controls of the individual monitors with a single display adjustment key switch set.

(b) Description of the Related Art

For a user to adjust display controls, i.e., brightness, contrast, color, H-position, V-position, etc., a monitor has a display adjustment key switch set with several buttons in its lower part, as shown in FIG. 1. The display adjustment key switch set comprises a MENU button to select display adjustment at any time while the monitor is in operation; UP, DOWN, LEFT, and RIGHT buttons to select a menu or to change the level of the selected menu up or down; a light emission diode (LED) to display the on/off status of the power; and a POWER button to switch the power on/off.

Unlike a computer with a single monitor, with a computer having a plurality of integrated monitors controlled by one CPU, as shown in FIG. 2, there is difficulty in mounting a separate display adjustment key switch set on each individual monitor, and the user is inconvenienced when adjusting display controls with the display adjustment key switch sets.

### SUMMARY OF THE INVENTION

It is an object of the present invention to provide a system that allows the user of a computer having a plurality of integrated monitors controlled by one CPU to control all the monitors with a single display adjustment key switch set, and to selectively adjust the display controls of the individual monitors.

In one aspect of the present invention, there is provided a display adjustment system for a computer having a plurality of integrated monitors, which is to selectively adjust display controls of the individual monitors with one central processing unit, the display adjustment system including: a plurality of integrated monitors controlled by one central processing unit; and an analog digital (AD) board for facilitating user selection of any one of the monitors using at least one key switch or a remote controller for the user to selectively adjust the display controls of the monitors, providing a display adjustment menu on the selected monitor upon the user selecting the monitor, and sending a display adjustment signal to the selected monitor upon the user controlling a key switch corresponding to the display adjustment menu of interest by a defined method.

The AD board includes: a display adjustment key switch set comprising at least one key switch for the user to selectively adjust the display controls of the monitors, the switch being mounted outside the display adjustment key switch set and controlled outside a body of the computer; and an on-screen display (OSD) controller for facilitating user selection of any one of the monitors via the display adjustment key switch set, providing a display adjustment menu on the selected monitor upon the user selecting the monitor, and sending a display adjustment signal to the selected monitor upon the user controlling any one switch on the key switch set corresponding to the display adjustment menu of interest by a defined method.

The display adjustment key switch set includes a select button for sequentially selecting the monitors whenever the user presses the select button, in correspondence to a specified monitor number assigned to the individual monitors.

The display adjustment key switch set further includes a remote controller receiver for receiving a control signal generated from the user's remote controller. The OSD controller facilitates user selection of any one of the monitors via the remote controller, provides a display adjustment menu on the selected monitor upon the user selecting the monitor, and sends a display adjustment signal to the selected monitor upon the user controlling a key switch on the remote controller corresponding to the display adjustment menu of interest by a defined method.

Accordingly, the present invention enables the user to select any one of the monitors via at least one key switch for selectively adjusting the display controls of the monitors, provides a display adjustment menu on the selected monitor upon the user selecting the monitor, and sends a display adjustment signal to the selected monitor upon the user controlling a key switch corresponding to the display adjustment menu of interest by a defined method.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic of a display adjustment key switch set of a general computer monitor;

FIG. 2 is an illustration of a computer having a plurality of integrated monitors with a display adjustment key switch set in accordance with an embodiment of the present invention;

FIG. 3 is a block diagram showing the position of a display adjustment key switch set on a display adjustment system for a computer having a plurality of integrated monitors in accordance with an embodiment of the present invention;

FIG. 4 is a schematic of the display adjustment key switch set shown in FIG. 3; and

FIG. 5 is a detailed block diagram of a display adjustment system for a computer having a plurality of integrated monitors in accordance with an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

Reference will now be made in detail to a display adjustment system for a computer having a plurality of integrated monitors in accordance with the preferred embodiments of the present invention, examples of which are illustrated in the accompanying drawings.

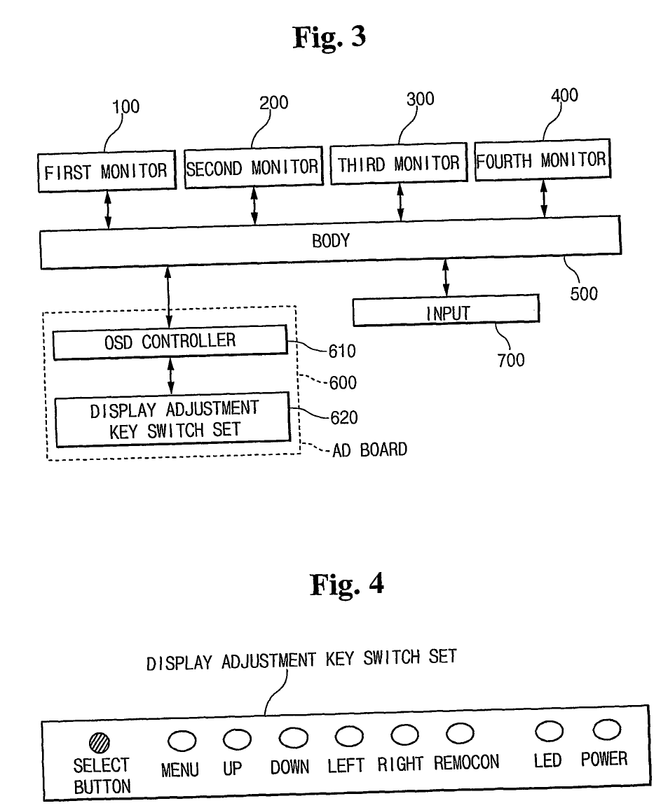

FIG. 3 is a block diagram showing the position of a display adjustment key switch set on a display adjustment system for a computer having a plurality of integrated monitors in accordance with an embodiment of the present invention, and FIG. 4 is a schematic of the display adjustment key switch set shown in FIG. 3.

Referring to FIG. 3, the display adjustment system for a computer having a plurality of integrated monitors according to the embodiment of the present invention comprises first to fourth monitors 100 to 400, a body 500, an analog digital (AD) board 600, and an input 700.

The computer system may be a full-sized computer or a super computer, as well as a normal personal computer. The number of monitors connected to the body 500 of the computer system is not specifically limited to four, and the user may connect two or more monitors to the body 500. The input 700 is an input device such as a keyboard or mouse that generates data upon the user entering commands on any one of the first to fourth monitors 100 to 400.

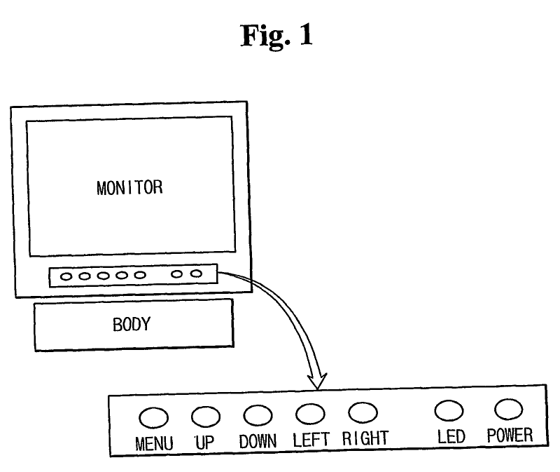

The AD board 600 comprises a display adjustment key switch set 620 and an on-screen display (OSD) controller 610 for the user to selectively adjust the display controls of the individual monitors. The OSD controller 610 is built in the body 500. The display adjustment key switch set 620 formed as a set of buttons as shown in FIG. 4 is mounted outside the body 500 for the user to adjust the display controls by pressing the buttons. In the schematic of the display adjustment key switch set 620 shown in FIG. 4, a SELECT button is provided in addition to the normal key switches shown in FIG. 1, so that the user can sequentially select the monitors while pressing the button.

The display adjustment key switch set 620 comprises at least one key switch for the user to selectively adjust the display controls of the s integrated monitors 100 to 400, the switch being mounted outside the body 500 for external adjustment of the display controls. In addition, as in the usual case of the display adjustment key switch, a remote controller receiver REMOCON is additionally provided so as to receive control signals generated from the user's remote controller and to allow display controls with the REMOCON instead of the display adjustment key switch.

The OSD controller 610 facilitates user selection of any one of the monitors 100 to 400 with the display adjustment key switch set 620, provides a display adjustment menu on the selected monitor upon the user selecting the monitor, and sends a display adjustment signal to the selected monitor upon the user controlling any one switch on the key switch set corresponding to the display adjustment menu of interest by a known method. In addition, the OSD controller 610 may send the display adjustment signal to the selected monitor as the user adjusts display controls by a known method using the key switches or buttons on the REMOCON.

Preferably, the display adjustment key switch set 620 has a SELECT button for sequentially selecting the monitors whenever the user presses the SELECT button, in correspondence to a specified monitor number assigned to each of the individual monitors. The specified monitor number refers to a number specifically assigned to each of the plural monitors.

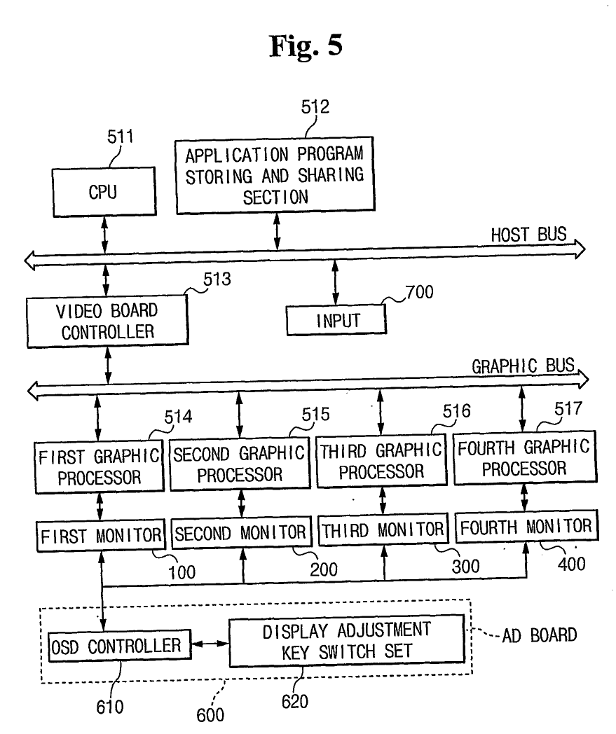

FIG. 5 is a detailed block diagram of a display adjustment system for a computer having a plurality of integrated monitors in accordance with an embodiment of the present invention. Now, a detailed description will be given as to the connection between the inside of the body 500 and the AD board 600 shown in FIG. 3, with reference to FIG. 5.

Referring to FIG. 5, the body 500 of the computer having a plurality of integrated monitors comprises a host bus, a graphic card port bus, a CPU 511, an application program storing and sharing section 512, a video board controller 513, and first to fourth graphic processors 514 to 517.

The CPU 511, which controls operation in a general computer, causes a driver to output first to fourth driving data from graphic data generated during the processing of the data of the first to fourth monitors 100 to 400 received from the input 700. The number of monitors used herein is not limited to four, so the number of CPUs can be increased so as to output data to more than four monitors or to process complicated operations caused by a large amount of data.

The application program storing and sharing section 512 stores various application programs used for the operation of the computer, shared drivers for processing graphic data, and other data.

The video board controller 513 determines the sequent order of input/output signals of the CPU 511, controls the output signals to be correctly sent to different sections, and processes insignificant signals to reduce the processing load of the CPU 511.

The graphic processors 514 to 517, functioning as a graphic card, operate upon receiving driving signals from the CPU 511, process the driving signals corresponding to the respective monitors to output picture signals, convert the picture signals to visual signals, and output the visual signals to the user's monitors 100 to 400.

The display adjustment system for a computer having a plurality of integrated monitors according to the embodiment of the present invention operates as follows. The operation of controlling the plural integrated monitors via the CPU 511 is well known in the art and will not be described in detail.

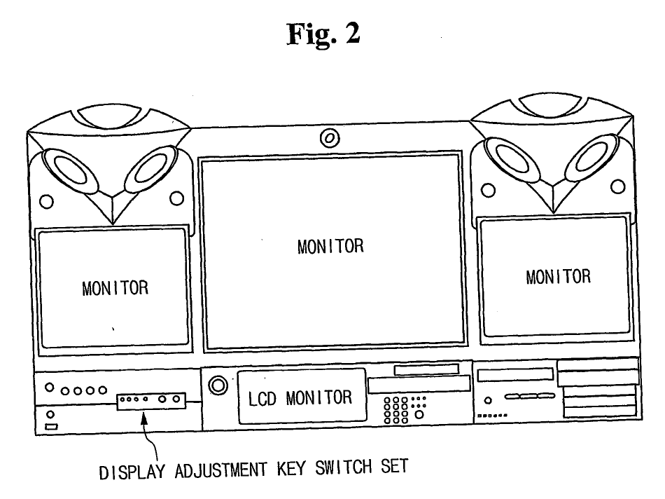

For display controls, the user of a computer having a plurality of integrated monitors 100 to 400 as shown in FIG. 2 selects any one of the monitors via a SELECT button among the switches on the display adjustment key switch set 620 shown in FIG. 4. If not specifically limited, the selection of a specific monitor may be achieved using a mechanical switch or an electrical signal generated from a customized MICOM. As in the usual case of the display adjustment key switch, an addition of a remote controller receiver REMOCON receiving control signals from the user's remote controller allows the user to select one monitor with the REMOCON instead of using the display adjustment key switch.

Upon the user selecting a monitor, the OSD controller 610 provides a menu as shown in Table 1 on the monitor so that the user can choose a display adjustment menu of interest. As in the usual case of display controls, the user may control any one switch on the display adjustment key switch set 620 corresponding to the display adjustment menu of interest by a known method, and the OSD controller 610 sends a display adjustment signal to the selected monitor. The control of the switch by a known method refers to pressing or turning the UP, DOWN, LEFT, and RIGHT key switches shown in FIG. 4 to adjust the level of the key switches. In addition, a user with a REMOCON may control the key switches or buttons on the REMOCON by a known method to send a display adjustment signal to the selected monitor.

Accordingly, the display adjustment system for a computer having a plurality of integrated monitors 100 to 400 according to the embodiment of the present invention allows the user to select any one of the monitors 100 to 400 via at least one key switch for selective display of controls of the monitors, provides a display adjustment menu on the selected monitor, and sends a display adjustment signal to the monitor upon the user controlling a key switch corresponding to the display adjustment menu of interest by a known method.

TABLE 1
Example of Display Adjustment Menu

| | | |
|---|---|---|
| Main Menu | Brightness | |
| | Contrast | |
| | H-Position | |
| | V-Position | |
| | Clock | |
| | Phase | |
| | Color | I (9300 K) |
| | | II (6400 K) |
| | | R |
| | | G |
| | | B |
| | Video Level | 0.7 V |
| | | 1.0 V |
| | Language | English |
| | | Deutsch |
| | | France |
| | | Espania |
| | | Italian |
| | Auto-Adjustment | |
| | TV | |
| | Information | |

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, the embodiment of the present invention allows the user of a computer having a plurality of integrated monitors to selectively adjust the display controls of the individual monitors with a single display adjustment key switch set for easy display controls, and it provides a separate adjustment device at a lower cost compared with the conventional system that has a separate display adjustment switch for every monitor.

Moreover, the present invention does not require a separate display adjustment switch for every monitor as in the case of the conventional system, and it secures the internal space of the body of a computer having a plurality of integrated monitors that is designed to have all the hardware such as a controller built in the body, thus saving the space for another use.

What is claimed is:

1. A display adjustment system for a computer having a plurality of integrated monitors, which is to selectively adjust display controls of the individual monitors with one central processing unit, the display adjustment system comprising:
a plurality of integrated monitors controlled by one central processing unit; and
an analog digital (AD) board for facilitating user selection of any one of the monitors using at least one key switch or a remote controller for the user to selectively adjust the display controls of the monitors, providing a display adjustment menu on the selected monitor upon the user selecting the monitor, and sending a display adjustment signal to the selected monitor upon the user controlling a key switch corresponding to the display adjustment menu of interest by a defined method.

2. The display adjustment system as claimed in claim 1, wherein the AD board comprises:
a display adjustment key switch set comprising at least one key switch for the user to selectively adjust the display controls of the monitors, the switch being mounted outside the display adjustment key switch set and controlled outside a body of the computer; and
an on-screen display (OSD) controller for facilitating user selection of any one of the monitors via the display adjustment key switch set, providing a display adjustment menu on the selected monitor upon the user selecting the monitor, and sending a display adjustment signal to the selected monitor upon the user controlling any one switch on the key switch set corresponding to the display adjustment menu of interest by a defined method.

3. The display adjustment system as claimed in claim 2, wherein the display adjustment key switch set comprises a select button for sequentially selecting the monitors whenever the user presses the select button, in correspondence to a specified monitor number assigned to the individual monitors.

4. The display adjustment system as claimed in claim 2, wherein the display adjustment key switch set further comprises a remote controller receiver for receiving a control signal generated from the user's remote controller,
wherein the OSD controller facilitates user selection of any one of the monitors via the remote controller, provides a display adjustment menu on the selected monitor upon the user selecting the monitor, and sends a display adjustment signal to the selected monitor upon the user controlling a key switch on the remote controller corresponding to the display adjustment menu of interest by a defined method.
